(19) United States
(12) Patent Application Publication
(10) Pub. No.: US 2009/0274937 A1
(43) Pub. Date: Nov. 5, 2009

(54) FUEL CELL SYSTEM WITH CIRCUIT MODULES

(75) Inventors: Timothy LaBreche, Ann Arbor, MI (US); Jason Krajcovic, Ann Arbor, MI (US)

Correspondence Address: Adaptive Materials Inc., 5500 S. State Rd., Ann Arbor, MI, 48108, US

(73) Assignee: ADAPTIVE MATERIALS, INC., Ann Arbor, MI (US)

(21) Appl. No.: 12/502,442

(22) Filed: Jul. 14, 2009

Related U.S. Application Data
(63) Continuation-in-part of application No. 11/683,666, filed on Mar. 8, 2007.

(51) Int. Cl. H01M 8/04; H01M 8/00

(52) U.S. Cl. 429/13; 429/23

(57) ABSTRACT

A solid oxide fuel cell system includes a fuel cell stack and a voltage providing member configured to provide a non-zero reference voltage to the fuel cell stack. The fuel cell stack includes a plurality of fuel cell stack subunits electrically coupled in series electrical connections and a plurality of field effect transistor assemblies. The field effect transistor assemblies include a switch member. Each field effect transistor assemblies is coupled to one of the fuel cell stack subunits and comprises a ground lead, a positive lead, a negative lead, and a bypass lead, a voltage between the ground lead and at least one of the positive lead and the negative lead providing an operating voltage for operating the switching member.

### CROSS-REFERENCE TO RELATED APPLICATIONS

This application is a continuation-in-part of U.S. patent application Ser. No. 11/683,666 filed on Mar. 8, 2007 which is hereby incorporated by reference herein.

### TECHNICAL FIELD

The disclosure relates to fuel cell systems having controllable circuit modules for modifying interconnection between fuel cells.

### BACKGROUND OF THE INVENTION

The material presented in this section merely provides background information to the present disclosure and may not constitute prior art. A fuel cell stack can comprise fuel cell subunits that include one or more electrochemical cells along with associated power and control electronics. The fuel cell stack subunits can be electrically coupled to bypass circuits so that when one of the fuel cell stack subunits fail, the failed fuel cell stack subunit can be bypassed and the remaining fuel cell stack units can continue delivering electrical power to power an external device.

Diodes can be utilized to prevent current flow to a failed fuel cell subunit thereby bypassing the failed fuel cell stack subunit by routing current to an alternate flow path through the bypass circuit. The diodes are associated with undesirably high power loss levels, wherein the amount of power loss is related to the amount of current flowing through the diode. When routing high current electrical energy through a diode, an undesirably high level of power is dissipated as heat through the diode. Therefore, utilizing diodes to bypass fuel cell stack subunits is undesirable for fuel cell stacks having high current levels.

Unlike, diodes, field effect transistors (“FETs”) are not associated with high levels of power loss when transmitting high current power. Field effect transistors can detect a switching voltage and actively switch between a base circuit and a bypass circuit based on whether the switching voltage is below or above a threshold voltage. However, the field effect transistor requires electricity above a predetermined gate voltage in order to perform the active switching function. When a fuel cell stack subunit fails, the fuel cell stack subunit is no longer able to provide the gate voltage and therefore, is unable to actively switch.

Further, during certain operating conditions, a passively controlled bypass system may be undesirable. For example, the passively controlled bypass system can permanently bypass a fuel cell stack subunit that experiences a temporary fault, but may otherwise be in operable condition. Further, selectively bypassing fuel cell stack subunits can provide increased efficiency and increased durability during certain operating conditions.

Therefore, fuel cell stacks with improved electronics controls are needed in the art.

### SUMMARY OF THE INVENTION

A solid oxide fuel cell system includes a fuel cell stack and a voltage providing member configured to provide a non-zero reference voltage to the fuel cell stack. The fuel cell stack includes a plurality of fuel cell stack subunits electrically coupled in series electrical connections and a plurality of field effect transistor assemblies. The field effect transistor assemblies include a switching member. Each field effect transistor assemblies is coupled to one of the fuel cell stack subunits and comprises a ground lead, a positive lead, a negative lead, and a bypass lead, a voltage between the ground lead and at least one of the positive lead and the negative lead providing an operating voltage for operating the switching member.

A method for controlling a fuel stack comprising a plurality of fuel cell subunits electrically connected to a plurality of controllable circuit modules and signally connected to a controller in accordance with an exemplary embodiment is disclosed herein. The method includes determining a command signal in the controller. The method further includes controlling the control circuit module based on the command signal.

### BRIEF DESCRIPTION OF THE DRAWINGS

FIG. 1 is a schematic diagram of a fuel cell stack in accordance with an exemplary embodiment of the present disclosure;

FIG. 2 is a diagram of a fuel cell stack subunit of the fuel cell stack of FIG. 1;

FIG. 3 is a schematic diagram of a fuel cell stack in accordance with another exemplary embodiment of the present disclosure;

FIG. 4 is a diagram of a fuel cell stack and a controller in accordance with an exemplary embodiment of the present disclosure;

FIG. 5 is a diagram of a fuel cell stack subunit in accordance with another exemplary embodiment of the present disclosure; and

FIGS. 6-9 are schematic diagrams of controllable circuit modules in accordance with exemplary embodiments of the present disclosure.

It should be understood that the appended drawings are not necessarily to scale, presenting a somewhat simplified representation of various preferred features illustrative of the basic principles of the invention. The specific design features of the fuel cell stack will be determined in part by the particular intended application and use environment. Certain features of the illustrated embodiments have been enlarged or distorted relative to others for visualization and understanding. In particular, thin features may be thickened for clarity of illustration. All references to direction and position, unless otherwise indicated, refer to the orientation of the fuel cell stack illustrated in the drawings.

### DETAILED DESCRIPTION OF THE PREFERRED EMBODIMENTS

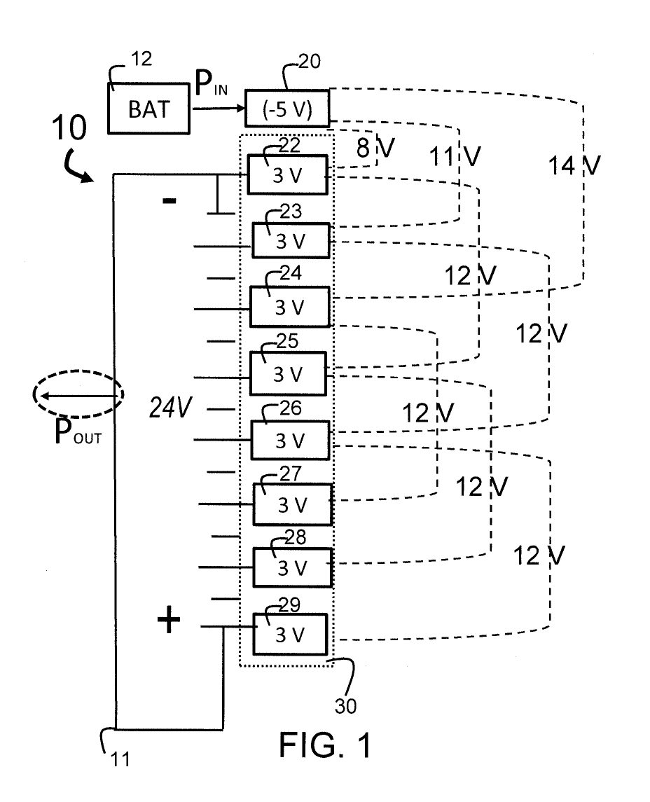

FIG. 1 schematically depicts a fuel cell system 10 electrically coupled to a battery (‘BAT’) 12. The fuel cell system 10 includes a bus 11, voltage providing member 20 and a fuel cell stack 30. The fuel cell stack 30 comprises a plurality of fuel cell stack subunits 22, 23, 24, 25, 26, 27, 28, and 29.

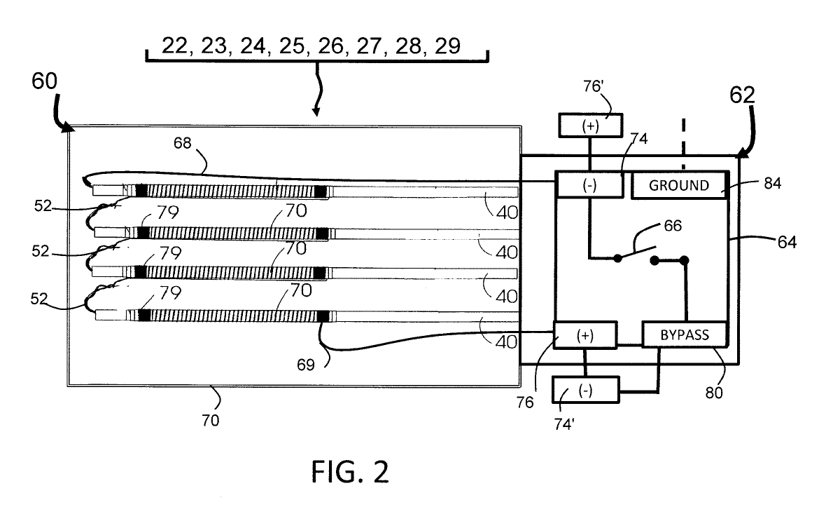

Referring to FIGS. 1 and 2, each of the fuel cell subunits include a cell portion 60 and a controllable circuit module 62. The cell portion 60 includes a plurality of solid oxide fuel cell tubes 40 having an electrochemically active portion 70 including an interior anode, an electrolyte, and an exterior cathode. The exemplary anode comprises nickel disposed within a ceramic skeleton, the exemplary electrolyte comprises yttria stabilized zirconia, and the exemplary cathode comprises lanthanum magnesium oxide. Fuel is routed through an interior of each of the fuel cell tubes 40, where the fuel reacts with the interior anode at the active portion 70 and air is provided to the cathode of the active portion 70, wherein the air reacts with the cathode. The anode and cathode reactions generate an electromotive force, generating electrical current through the plurality of fuel cell tubes 40. A cathode current collector 79 is wrapped around the electrochemically active portion 70 such that the cathode current collector 79 can transfer current to the cathode and an anode current collector (not shown) is disposed within the fuel cell tube such that the anode current collector can transfer current away from the anode. For further illustration of exemplary fuel cell tubes and fuel cell current collectors see U.S. application Ser. No. 11/566,457 to Crumm, et al. entitled SOLID OXIDE FUEL CELL WITH IMPROVED CURRENT COLLECTION, the entire contents of which is hereby incorporated by reference herein. The plurality of fuel cell tubes 40 are electrically connected to the controllable circuit module 62 through electrical lead wires 68 and 69.

The control circuit 10 includes a field effect transistor (‘FET’) assembly 64 including a switching member 66, a negative lead terminal 74, a positive lead terminal 76, and a ground terminal 84. Although the switching member 66 is schematically depicted as a switch, in exemplary embodiments, the switching member can comprise any component that provides switching functionality and can be for example a transistor or other switching device. The field effect transistor assembly 64 further includes an FET configured to detect a voltage level across the positive terminal 74 and the negative terminal 76. When the voltage detected between the positive terminal 74 and the negative terminal 76 is less than a threshold voltage the switching member 66 is opened and current bypasses the plurality of fuel cells 40. However, in order to actively control the switching member 66, the FET requires a gate voltage greater than a threshold greater than voltage. Therefore, the FET operates utilizing gate voltages between the ground terminal 84 and the negative terminal 74. In an alternative embodiment, the FET can operate utilizing a voltage between the ground terminal and the 84 and the positive terminal 74.

The exemplary FET is a p-type metal oxide field effect transistor (‘MOSFET’) comprising silicon. Due to the low operating temperatures of the MOSFET, and the relatively high operating temperatures of the fuel cell tubes, for example, about 750 degrees Celsius, the MOSFETs are disposed outside the insulative housing 70 enclosing the plurality of fuel cells 40. In an alternate embodiment, the FET comprises silicon carbide, therefore allowing placement of the FET in closer proximity to the plurality of fuel cells 40. In an alternate embodiment, an n-type MOSFET as well as other transistors can be utilized in place of a p-type MOSFET. Further various other types of switching transistors including various transistors include NPN transistors, PNP transistors, JFET transistors, solid state switching elements, other field effect transistors, and other MOSFETs, can be utilized in place of the exemplary FET.

FIG. 1 further displays exemplary voltage levels being actively provided by the voltage providing member 20 (‘−5V’), by each fuel cell stack subunit (‘3V’) outputted from the fuel cell stack 30 (‘24 V’). Also depicted are reference ground voltage provided to field effect transistors (‘FET’) of the fuel cell stack subunit 22 referenced to the voltage providing member 20 (‘8’ V), a FET of the fuel cell stack subunit 23 referenced to the voltage providing member 20 (‘11 V’), a FET of the fuel cell stack subunit 24 referenced to the voltage providing member 20 (‘14 V’), a FET of the fuel cell stack subunit 25 referenced to the fuel cell stack subcomponent 22 (‘12 V’), a FET of the fuel cell stack subunit 26 referenced to the fuel cell stack subunit 23 (‘12 V’), a FET of the fuel cell stack 27 referenced to the fuel cell stack subunit 24 (‘12 V’), a FET of the fuel cell stack 28 referenced to the fuel cell stack subunit 25 (‘12 V’), and a FET of the fuel cell stack 29 referenced to the fuel cell stack subunit 26 (‘12 V’).

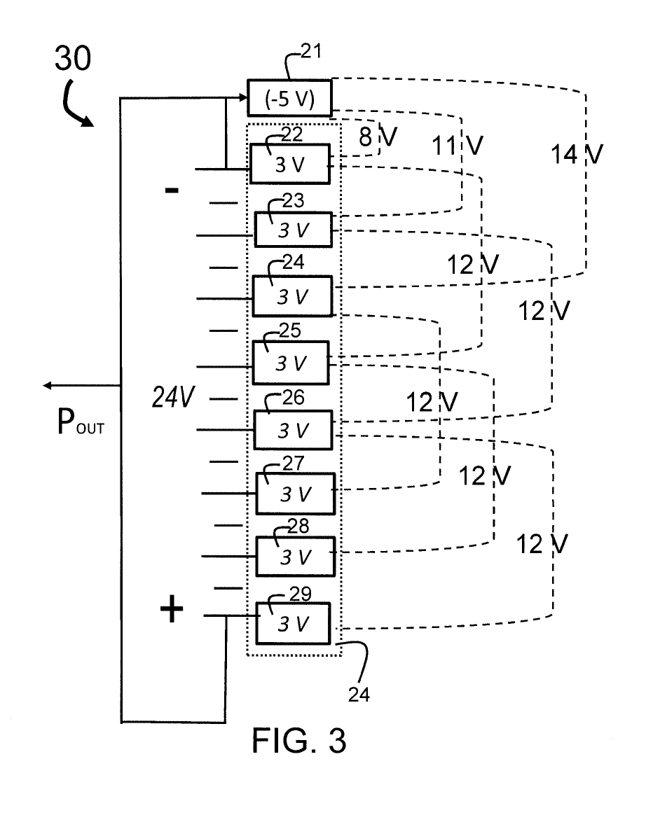

The voltage providing member 20 provides a re-referenced ground voltage to a ground terminal (FIG. 3) of field effect transistors (‘FET’) of the fuel cell stack subunits 24, thereby providing the operating gate voltages to the fuel cell stack subunits 24. The voltage providing member indicates a ‘−5 V’ exemplary power source for the plurality of fuel cells 24, however, in alternate embodiments, the voltage providing member can provide other voltage levels. The voltage providing member can provide a negative voltage level when, for example, p-type FETs are utilized within the fuel cell stack 40. The voltage providing member can provide a positive voltage level when, for example, when n-type FETs are utilized within the fuel cell stack 40. The voltage providing member 20 includes a charge pump that provides DC-DC voltage conversion between the voltage level of the external battery and the desired voltage providing member voltage.

Advantageous in the design of the fuel cell stack 20 is that the voltage providing member provides voltage separately for one of the FETs separately from the fuel cell stack subunits. Therefore, when one of the fuel cell stack subunits fail, the FETs of the remaining fuel cell stack subunits continue to reference sufficient ground voltage to monitor voltage and to provide bypass switching. Exemplary voltage providing members include an electrical lead having a selected voltage that is converted from a direct current voltage converter or a voltage supplied by an external power source other than the fuel cell subunit, for example, a battery or capacitor. FIG. 3 depicts a fuel cell stack 30 that is substantially similar to the fuel cell stack 10, however, the fuel cell stack 30 includes a voltage member 21 comprising a D.C. converter that converts the 24 V output power fuel cell to −5 V at low current consumption thereby minimizing parasitic power loss from the voltage providing member 21.

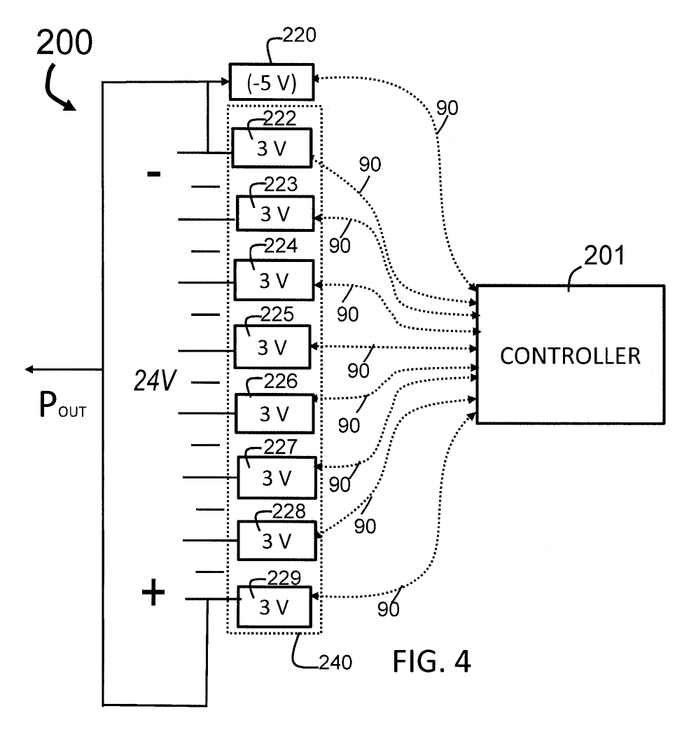

FIG. 4 depicts a fuel cell system 200 including a controller 201, a voltage providing member 220 and a fuel cell stack 240. The fuel cell stack 240 includes fuel cell stack subunits 222, 223, 224, 225, 226, 227, 228, and 229. The controller 201 actively monitors each of the fuel cell stack subunits and the voltage providing member 220.

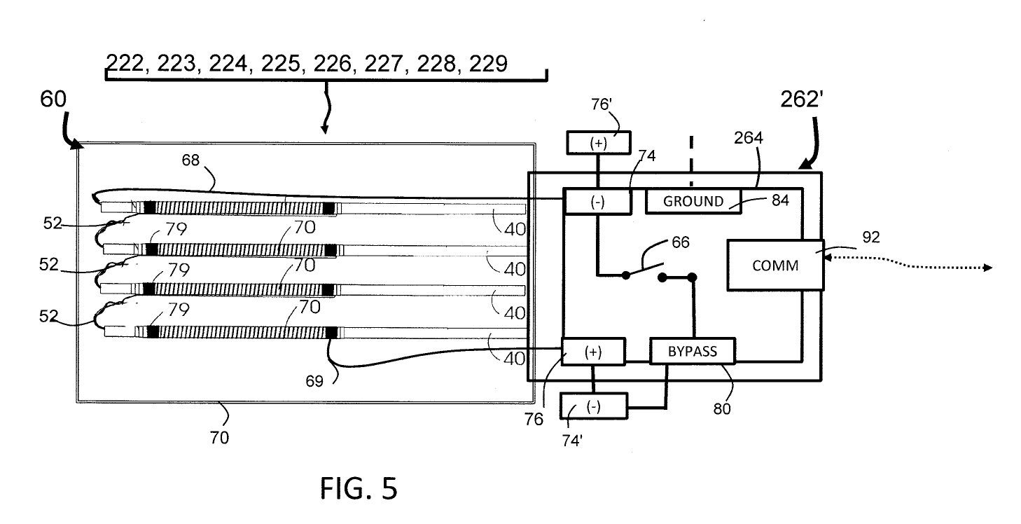

FIG. 5 depicts one of the fuel cell stack subunits of the fuel cell stack 200. The fuel cell stack subunits are substantially similar to those the fuel cell stack subunits of fuel cell stack 10 depicted in FIG. 1, however, the fuel cell stack subunits include a controllable circuit module 226 that includes a field effect transistor terminal 264 that includes a communications terminal (‘COMM’) 92 configured to receive commands from the controller 201 and communicate information to the controller 201. Voltage and current is continuously monitored across the terminals 74 and 76 via voltage and current sensors (not shown). Exemplary information that can be communicated between the controllable circuit module 226 and the controller 201 includes switching member position commands and measured power parameters, for example, power levels, voltage levels, and current levels.

By actively controlling opening and closing of switching member positions, the fuel cell stack 200 can provide increased durability and energy efficiency to the fuel cell stack 60. For example, the controller 201 can command the opening of the switching member 66 when energy conservation is desired. Further, the controller 201 can command closing of the switching member 66 when a higher than desirable operating temperature is measured, and subsequently command opening of the switching member 66 when the measured operating temperature falls below a threshold temperature. Further, the switching member 66 can open when a current level lower than a threshold current level is measured or when a voltage level lower than a threshold voltage level is measured. Still further, the switching member 66 can open when a voltage degradation rate greater than a threshold voltage degradation rate is measured or when a current degradation rate greater than a threshold current degradation rate is measured.

When one of the switching member 66 is in an open position the control system can send periodic commands to the switching member 66 to actuate the switching member 66 to a closed position. By periodically reactivating failed fuel cell stack subunits, the control system can reactive fuel cell subunits that have been deactivated due to temporary faults, but that are still capable of generating power.

In an exemplary embodiment when the fuel cell subunit is bypassed, hydrogen containing fuel, a reducing fluid, continues to flow through each of the fuel cell tubes even though the fuel cell tubes. Since current is not actively leaving the fuel cell tubes when the fuel cell tubes are bypassed oxygen is not conducted through the electrolyte, the conducted oxygen is not available for reaction with the hydrogen containing fuel. Therefore, the hydrogen containing fuel has a greater reducing potential to perform a fuel cell regeneration function to regenerate oxidized nickel in the fuel cell anode by reducing the nickel, which can thereby regenerate the fuel cell. The fuel cell regeneration function can be controlled in response to degraded operating performance of one of the fuel cell stack subunits. Further, the fuel cell generation function can be controlled to by periodically bypassing the circuit for a selected time period, for example, by opening the bypass circuit for a twenty second cycle every five minutes. Further, the fuel cell stack subunits can be controlled so that only one of the fuel cell stack subunits is open at any given time, thereby maintaining consistent fuel cell stack output power levels.

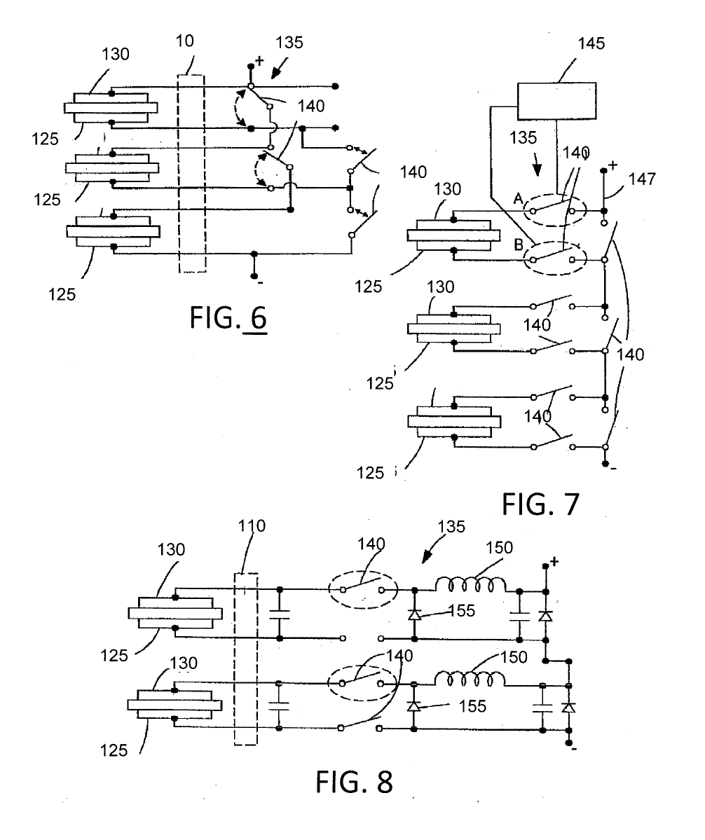

FIGS. 6-9 show exemplary electrical control circuits than can be controlled by a controller 201 to provide desired functionality to a fuel cell system. Each of the control circuit can be utilized within the control circuit 262 (FIG. 5). In particular FIG. 6 depicts a control circuit 135 comprising multiple switching members 140 to actively manage coupling and decoupling of fuel cell electrodes 125 and 135. In this manner, the connection between adjacent cells 115 may be switched from series to parallel. Additionally, the anodes 125 of adjacent cells 115 are electrically coupled via an actively controlled element 140 to allow the anodes 125 of adjacent cells 115 to be connected or disconnected. Again this arrangement allows for the anodes 125 and cathodes 130 of adjacent cells 115 to be linked with either of each other to provide series or parallel connections between adjacent fuel cells 115.

Referring to FIG. 7, there a schematic diagram depicts a fuel cell anode 125 and a cathode 130. An actively controlled switching member 140 is selectively connected both the cathode 130 and anode 125 to a bus 147. Additionally, actively switching members 140 are connected between the cathode 130 and anode 125 of the buss 147. As can be seen from the figure, either A or B may be decoupled from the buss 147 or A and B may be decoupled from the buss 147. Additionally, the actively controlled switching members 140 on the buss 147 may facilitate decoupling of the individual electrodes 125, 130 from the buss 147.

Referring to FIG. 8, additionally, the interconnection between the fuel cells may be modified to adjust a voltage output of the stack 120. Similarly, an interconnection between the cells 115 may be modified adjusting a current output of the fuel cell. Additionally, interconnection between the cells 115 may be modified managing a power output of the stack 120. Various other parameters may also be adjusted through the modification of the interconnection between the cells 115 including adjusting an efficiency of the plurality of fuel cells 115 as well as actively controlling the direct current of the stack 120. For example an efficiency of the plurality of fuel cells 115 of the stack may be modified to produce more heat rather than produce more electricity to adjust a temperature of the fuel cell such that it can be controlled to produce a desired operating condition. Additionally, the interconnection between the cells 115 may be modified managing a power output of the stack to prevent back loading of live cells 115 and improve an overall efficiency of the solid oxide fuel cell 105.

As can be seen in FIG. 8, the bypass circuit 135 includes an actively controlled element 140 shown as a switch as well as a capacitor 150 and diode 155. Such a structure allows for the active controlling of the direct current produced by the stack 120 such that the DC output of the fuel cell stack can be actively controlled by the controller 21.

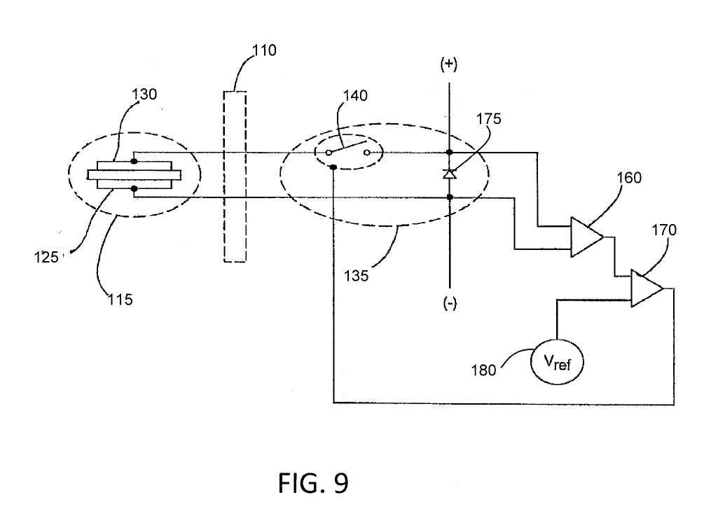

In one aspect of the invention, and referring to FIG. 9, there is shown an actively controlled element 140 that includes the switch. As can be seen in the figure, the switch includes a precision comparator 160, precision reference 165, and a logic driver 170. This bypass circuit 35 acts as an actively controlled diode allowing the bypass circuit 135 to be utilized to bypass various of the fuel cells 115 or to perform other functions such as described above including the adjustment of the efficiency of the cells 115, the management of the power output, current output, or voltage output of a stack 120 of interconnected fuel cells 115.

While the above description has included a general description of a solid oxide fuel cell system. The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A solid oxide fuel cell system comprising:
a fuel cell stack including:
a plurality of fuel cell stack subunits electrically coupled in series electrical connections; and
a plurality of field effect transistor assemblies comprising a bypass switch, each field effect transistor assemblies is coupled to one of the fuel cell stack subunits, each field effect transistor assembly comprising a ground lead, a positive lead, a negative lead, and a bypass lead, a voltage between the ground lead and at least one of the positive lead and the negative lead providing an operating voltage for operating the bypass switch and
a voltage providing member configured to provide a non-zero reference voltage to the ground lead of at least one of the fuel cell stack subunits.

2. The solid oxide fuel cell system of claim 1, further comprising a direct voltage converter providing the non-zero reference voltage to the ground lead of the at least one of the fuel cell stack subunits.

3. The solid oxide fuel cell system of claim 2, wherein the voltage providing member provides a negative reference voltage to a p-type field effect transistor.

4. The solid oxide fuel cell system of claim 2, wherein the voltage providing member provides a positive reference voltage to an n-type field effect transistor.

5. The solid oxide fuel cell system of claim 2, wherein the direct voltage converter converters a voltage level of the fuel cell stack to the non-zero reference voltage.

6. The solid oxide fuel cell system of claim 2, further comprising a battery wherein the direct voltage converter converts a voltage level of the battery to the non-zero reference voltage.

7. The solid oxide fuel cell system of claim 2, wherein the direct voltage converter comprises a charge pump.

8. The solid oxide fuel cell system of claim 1, wherein the fuel cell stack subunits comprise at least one fuel cell tube.

9. The solid fuel cell system of claim 8, further comprising insulated walls defining an insulated chamber, wherein the fuel cell tube is disposed within the insulated walls and the field effect transistor assembly is disposed outside the insulated walls.

10. The solid oxide fuel cell system of claim 1, wherein the field effect transistor controlled by a central processing unit based controller.

11. A solid oxide fuel cell system comprising:
a fuel cell stack comprising:
a plurality of fuel cell stack subunits, each subunit being in electrical connection with a second fuel cell stack subunit and a plurality controllable circuit modules, each control circuit module being coupled to one of the fuel cell stack subunits, and
a controller receiving output signals from each of the controllable circuit modules and configured to provide input signals to each of the controllable circuit modules.

12. The solid oxide fuel cell stack of claim 10, wherein the input signals comprises a switching command.

13. The solid oxide fuel cell stack of claim 11, wherein the output signals comprise at least one of a switch position, a voltage level, and a current level.

14. The solid oxide fuel cell stack of claim 11, wherein each controllable circuit module are configured to convert connections between a first voltage and a second voltage level.

15. The solid oxide fuel cell stack of claim 11, further comprising a voltage providing member configured to provide a non-zero reference voltage to the ground lead of at least one of the fuel cell stack subunits.

16. The solid oxide fuel cell of claim 11, further comprising a direct voltage converter providing the non-zero reference voltage to the ground lead of the at least one of the fuel cell stack subunits, wherein the controller provides closed loop control to the direct current converter.

17. A method for controlling a fuel stack comprising a plurality of fuel cell subunits electrically connected to a plurality of controllable circuit modules and signally connected to a controller, the method comprising:
determining a command signal in the controller; and
controlling the control circuit module based on the command signal.

18. The method of claim 17, further comprising:
routing output signals from the controllable circuit modules to the controller, the output signals including at least one of a switch position, a voltage level, and a current level; and
determining the command signal based on the output signal.

19. The method of claim 17, further comprising:
detecting fuel cell anode oxidation and
providing a reducing fluid to the fuel cell anode when the anode oxidation is detected.

20. The method of claim 17, further comprising periodically providing a reducing fluid to the fuel cell anode.
